(19) United States
(12) Patent Application Publication
(10) Pub. No.: US 2010/0075889 A1
(43) Pub. Date: Mar. 25, 2010

(54) FILM AND METHOD FOR PRODUCING THE SAME

(75) Inventor: Toshiyuki KATAGIRI, Minami-ashigara-shi (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/564,203

(22) Filed: Sep. 22, 2009

(30) Foreign Application Priority Data
Sep. 22, 2008 (JP) 2008-242684

(51) Int. Cl. C11D 17/00; B05D 7/04; B05D 3/06

(52) U.S. Cl. 510/445; 427/177; 427/487

(57) ABSTRACT

The film of the present invention is provided, on the same long base material, with functional layer and a cleaning layer formed at the end surface in the running direction. With the cleaning layer positioned at the forefront, the film is delivered through a film forming apparatus equipped with a coater, etc., whereby the cleaning layer can remove foreign matters adhered on transporting rollers. The functional layer passes through after the cleaning layer has removed foreign matters. The film can be delivered without damaging the functional layer which is to be a product, and various treatments can further be carried out to the functional layer. According to the film of the present invention, the treatments can be carried out to the cleaning layer and functional layer on the same base material, thereby reducing the time and labor losses associated with the cleaning.

### BACKGROUND OF THE INVENTION

1. Field of the Invention

The present invention relates to a film and a method for producing the film.

2. Description of the Related Art

Optical films such as gas barrier film, protection film, optical filter, anti-reflection film, etc., are used for various devices including optical element, display devices such as liquid crystal display, organic EL display, etc., semiconductor device, thin film solar cell, etc.

Optical films are typically manufactured by the roll-to-roll process. For example, they are produced by feeding a long synthetic resin base material from a roller around which the long base material is wound, applying a coating liquid onto the long base material while the material is transported by transporting rollers, forming a functional layer on the long base material by curing the coating liquid, and winding up the long base material (Japanese Patent Application Laid-Open No. 2001-343505).

Recently, as image display devices are upsized and their resolutions are higher, it is desired that specks, foreign matters, etc., adhered on various optical films be reduced.

To prevent foreign matters on the transporting roller from adhering to the functional layer, a process has been employed wherein all transporting rollers are cleaned manually and PET for cleaning is delivered before treatments.

### SUMMARY OF THE INVENTION

However, the process described above requires time consuming work, posing a productivity problem.

The present invention is accomplished in view of such a circumstance, and an object of the invention is to provide a film which is produced by forming and treating the cleaning layer and functional layer on the same base material and is highly productive as a result of this, and a method for producing the film.

To achieve the object mentioned above, the film of the present invention comprises a long base material, a cleaning layer formed at an end of the long base material surface in a running direction, and a functional layer formed on an area of the long base material surface where the cleaning layer is not formed.

The film of the present invention is provided, on the same long base material, with functional layer and a cleaning layer formed at the end surface in the running direction. With the cleaning layer positioned at the forefront, the film is delivered through a film forming apparatus equipped with a coater, etc., whereby the cleaning layer can remove foreign matters adhered on transporting rollers. The functional layer passes through after the cleaning layer has removed foreign matters. The film can be delivered without damaging the functional layer which is to be a product, and various treatments can further be carried out to the functional layer. According to the film of the present invention, the treatments can be carried out to the cleaning layer and functional layer on the same base material, thereby reducing the time and labor losses associated with the cleaning.

The film of the present invention, in the invention described above, preferably has the cleaning layer and functional layer having the same composition and formed under different film forming conditions.

Since the cleaning layer and the functional layer have the same composition and are formed under different film forming conditions, the cleaning layer and functional layer can be formed continuously on the long base material.

The film of the present invention, in the invention described above, preferably has the cleaning layer and the functional layer containing a radiation curable monomer or oligomer.

Since the radiation curable monomer or oligomer is contained, the cleaning layer and functional layer can be easily formed on the long base material by changing radiation intensities.

To achieve the object described earlier, the film production method of the present invention comprises the steps of feeding a long base material, applying a coating liquid to the long base material, forming a cleaning layer by treating the applied coating liquid under first film forming conditions, forming a functional layer by treating the applied coating liquid under second film forming conditions which are different from the first film forming conditions, and winding up the long base material.

According to the method described above, the cleaning layer and functional layer can be easily formed on the same base material.

The film production method of the present invention, in the invention described above, preferably further comprises a step of forming a cleaning layer by treating the coating liquid under first film forming conditions after the step of forming the functional layer.

Since the method further comprises the step of forming the cleaning layer after the step of forming the functional layer, the cleaning layer is formed on each end of the film. The film, once wound up into a roll, may be pulled out again and treated for other layers to be laminated thereon. Namely, either end of such a film can be the forefront in the next step. Accordingly, when a plurality of layers are laminated on the long base material, the cleaning layers provided on both ends enable the removal of foreign matters in any steps before the functional layer is treated.

The film production method of the present invention, in the invention described above, preferably uses the coating liquid containing a radiation curable monomer or oligomer.

According to the film production method of the present invention, in the invention described above, the second film forming conditions are different in a radiation intensity from the first film forming conditions, and the radiation intensity in the first film forming conditions is preferably lower than the radiation intensity in the second film forming conditions.

The cleaning layer and functional layer can be easily formed on the same long base material by changing radiation intensities.

In the film and method of the present invention, intensity of irradiation to form a cleaning layer is preferably equal to or lower than one fifth (more preferably, equal to or lower than one tenth) of intensity of irradiation to form a normal product portion.

According to the present invention, the cleaning layer and functional layer can be formed and treated on the same base material, whereby a highly productive film and a method for producing such a film can be provided.

### BRIEF DESCRIPTION OF THE DRAWINGS

FIG. 1 is a drawing showing the film of the present invention;

FIG. 2 is a drawing showing an embodiment of an apparatus for carrying out the method for producing a film;

FIG. 3 is a drawing showing an embodiment of an apparatus for forming a thin film on the film; and

FIG. 4 is a drawing showing another embodiment of the film of the present invention.

### DETAILED DESCRIPTION OF THE PREFERRED EMBODIMENTS

Preferred embodiments of the present invention are hereinafter described with reference to the accompanied drawings. The present invention is described with reference to the following preferred embodiments, but can be modified in a variety of manners without departing from the scope of the invention, and thus other embodiments can be used in addition to those described herein. Accordingly, all variations within the scope of the present invention are encompassed in the scope of the claims. Further, all numerical ranges expressed using “(from) . . . to . . . ” in the specification should be understood to mean a range which includes the numbers shown before and after the “(from) . . . to . . . ”.

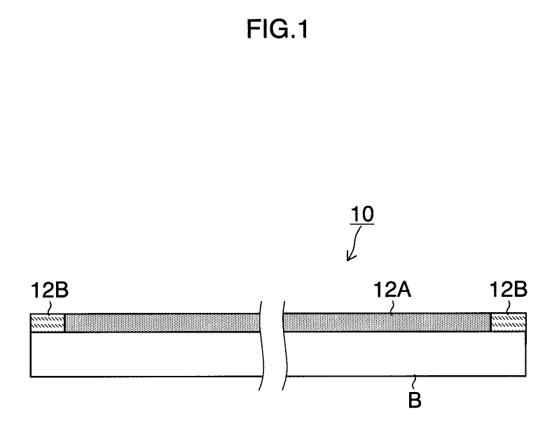

FIG. 1 is a conceptual drawing showing the film of the present invention. As shown in FIG. 1, the film 10 comprises a long base material B (unprocessed film), a functional layer 12A formed on the surface of the base material B and containing a given polymer as a main ingredient, and cleaning layers 12B formed on both ends of the base material B.

In the present invention, the base material B is not limited, and usable material includes resin films such as PET films, etc.; metal sheets such as aluminium sheets, etc.;

and any other base materials (base films) used for various functional films such as gas barrier films, optical films, protection films, etc., insofar as the films of the functional layer 12A and cleaning layer 12B can be formed thereon.

The functional layer 12A, for example, can also function as a primer layer for a thin film composed of an inorganic component and laminated thereon. The functional layer 12A can enhance the adherence between the base material B and the thin film.

The functional layer 12A further functions as a cushioning layer. The function of the functional layer 12A is not limited to those described above, and may also serve as, e. g., an optical compensation layer or anti reflection layer.

The cleaning layer 12B may be any layer as long as it is adhesive, collects foreign matters on a transporting roller when it passes along the roller, and removes the foreign matters from the roller. The adhesive force of the cleaning layer 12B preferably ranges from 0.02 to 0.5 N/25 mm.

The film 10 is delivered so that the cleaning layer 12B is positioned at the leading end of the film running direction, and various treatments are performed to the functional layer 12A on the film 10. Since foreign matters have been removed by the cleaning layer 12B, foreign matters can be prevented from adhering to the functional layer 12A.

It is preferred that the functional layer 12A and cleaning layer 12B be composed of the same composition. Specific components for these layers are films containing a radiation curable monomer or oligomer as a main ingredient. Specifically, usable monomers or oligomers are preferably those having two or more ethylene unsaturated double bonds and addition polymerized by light irradiation. Such monomers and oligomers are compounds containing at least one addition polymerizable ethylene unsaturated group and having a boiling point of 100° C. or higher at ordinary pressure. Examples include monofunctional acrylates and monofunctional methacrylates such as polyethylene glycol mono(meth)acrylate, polypropylene glycol mono(meta)acrylate, phenoxyethyl(meth)acrylate, etc.; polyethylene glycol di(meta)acrylate, polypropylene glycol di(meta)acrylate, trimethylolethane triacrylate, trimethylolpropane tri(meta)acrylate, trimethylolpropane diacrylate, neopentyl glycol di(meth)acrylate, pentaerythritol tetra(meth)acrylate, pentaerythritol tri(meth)acrylate, dipentaerythritol hexa(meth)acrylate, dipentaerythritol penta(meth)acrylate, hexane diol di(meth)acrylate, trimethylolpropane tri(acryloyloxypropyl)ether, tri(acryloyloxyethyl)isocyanurate, tri(acryloyloxyethyl)cyanurate, glycerol tri(meth)acrylate; and polyfunctional acrylates and polyfunctional methacrylates such as those wherein ethylene oxide or propylene oxide is added to a polyfunctional alcohol such as trimethyrolpropane, glycerol, or the like, and the adduct is subsequently methacrylated.

Further examples include urethane acrylates such as those described in Japanese Examined Application Publication No. 48-41708, Japanese Examined Application Publication No. 50-6034 and Japanese Patent Application Laid-Open No. 48-37193; polyester acrylates described in Japanese Patent Application Laid-Open No. 48-64183, Japanese Examined Application Publication No. 49-43191 and Japanese Examined Application Publication No. 52-30490; and polyfunctional acrylates and methacrylates such as epoxy acrylates which are reactive products of an epoxy resin and a (meth)acrylic acid.

Among these, preferred are trimethylolpropane tri(meth)acrylate, pentaerythritol tetra(meth)acrylate, dipentaerythritol hexa(meth)acrylate, and dipentaerythritol penta(meth)acrylate.

Furthermore, the “polymeric compound B” described in Japanese Patent Application Laid-Open No. 11-133600 is also preferable in addition to those described above.

Examples of usable photopolymerization initiators or photopolymerization initiator systems include vicinal polyketaldonyl compound disclosed in U.S. Pat. No. 2,367,660 specification; acyloin ether compound described in U.S. Pat. No. 2,448,828 specification; alpha-hydrocarbon-substituted aromatic acyloin compound described in U.S. Pat. No. 2,722,512 specification; multi-nucleus quinone compounds described in U.S. Pat. Nos. 3,046,127 and 2,951,758 specifications; combinations of triarylimidazole dimmer and p-aminophenyl ketone described in U.S. Pat. No. 3,549,367 specification; benzothiazole compounds and trihalomethyl-s-triazine compounds described in Japanese Examined Application Publication No. 51-48516, trihalomethyl-triazine compounds described in U.S. Pat. No. 4,239,850 specification and trihalomethyl oxadiazol compounds described in U.S. Pat. No. 4,212,976 specification. Trihalomethyl-s-triazine, trihalomethyl oxadiazol and triarylimidazole dimmer are particularly preferred.

Furthermore, the “polymerization initiator C” described in Japanese Patent Application Laid-Open No. 11-133600 is also preferable. The amount of a photopolymerization initiator used preferably ranges from 0.01 to 20% by mass of the solid content of the coating liquid, and more preferably from 0.5 to 10% by mass. Light irradiation for the polymerization of liquid crystalline compound is preferably performed using ultraviolet light. The irradiation energy is preferably in the range of 20 mJ/cm² to 50 J/cm², and more preferably 100 to 2000 mJ/cm². To accelerate the photopolymerization, the light irradiation may be performed under heat.

The polymerization of acrylates and methacrylates are inhibited by the oxygen in the air. For this reason, when the organic film 12 is used in the invention, it is preferred that an oxygen level or oxygen partial pressure be reduced at the time of the polymerization. When an oxygen level at the time of the polymerization is reduced by the nitrogen replacement method, an oxygen level is preferably 2% or less, and more preferably 0.5% or less. When an oxygen partial pressure at the time of the polymerization is reduced by the decompression procedure, the total pressure is preferably 1000 Pa or less, and more preferably 100 Pa or less. It is particularly preferred to carry out UV radiation polymerization by irradiating an energy of 2 J/cm² or more under the condition of a reduced pressure of 100 Pa or less.

In the invention, the polymerization ratio of the monomer is preferably 80% or more, more preferably 85% or more, and further preferably 90% or more. The polymerization ratio used herein means the ratio of reacted polymerizable groups out of the total polymerizable groups in the monomer mixture (e.g., acryloyl group and methacryloyl group in acrylates and methacrylates).

Described next is the method for forming the films of the functional layer 12A and cleaning layer 12B on the base material B using an organic film forming apparatus 20 as an example.

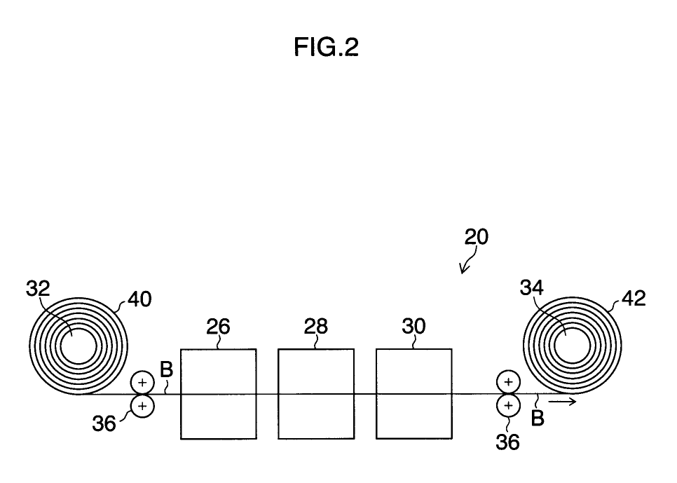

FIG. 2 conceptually shows an embodiment of the organic film forming apparatus 20 for carrying out the production method of the film 10. The organic film forming apparatus 20 is equipped with a coating device 26, a heating device 28 and a UV irradiation device 30. The coating liquid containing pre-prepared radiation curable monomers or oligomers is applied to the base material B using the coating device 26, dried using the heating device 28 and polymerized by the UV irradiation device 30 to form the films of the functional layer and cleaning layer.

The organic film forming apparatus 20 forms an organic film by the roll-to-roll process, whereby the base material B is loaded around a shaft 32 as a base material roll 40 and carried in the longitudinal direction while the films of the cleaning layers and functional layer are formed thereon. The base material B on which the films of the cleaning layer and functional layer have been formed is wound up around a winding shaft 34.

The base material B unrolled from the base material roll 40 is guided by the transporting roller 36 and first delivered to the coating device 26. At the coating device 26, a coating liquid containing radiation curable monomers or oligomers is applied to the surface of the base material B.

The base material B is then delivered to the heating device 28. At the heating device 28, the solvent in the coating liquid applied by the coating device 26 is dried. The heating method of the coating liquid is not limited, and any known heating methods such as heating using a heater, heating by warm air, etc., can be employed insofar as it can heat the coating liquid before the base material B reaches the UV irradiation device 30 in accordance with the feeding speed of the base material B.

The base material B is then delivered to the UV irradiation device 30. At the UV irradiation device 30, radiation curable monomers or oligomers are polymerized by irradiating UV (ultraviolet ray) to the coating liquid which has been applied by the coating device 26 and heat dried by the heating device 28.

In an embodiment of the present invention, when the base material B to which the coating liquid is applied passes through the UV irradiation device 30, a comparatively mild UV is irradiated for several seconds. The coating liquid containing radiation curable monomers or oligomers is polymerized, but cured and forms a film with the adherence maintained since the UV irradiation intensity is weak. Due to a comparatively weak UV irradiation, the cleaning layer can be formed at the end of the running direction of the base material B.

The base material B, on which the cleaning layer has been formed, is guided by the transporting roller 36 and delivered to the winding shaft 34. The base material B, with the cleaning layer having been already formed thereon, can remove foreign matters on the transporting roller 36 when passing therethrough.

Further, the adherence of the cleaning layer can prevent a disalignment of the base material B when it is wound up around the winding shaft 34.

After forming the cleaning layer, the coating liquid is irradiated with UV at a higher irradiation intensity. Thus, the functional layer is formed on the base material B. The base material B is guided by the transporting roller 36 and continuously wound up by the winding shaft 34. The transporting roller 36, from which foreign matters have been already removed by the cleaning layer, can prevent foreign matters on the transporting roller from adhering to the functional layer.

Described next is the case of forming a thin film layer, using a vacuum film forming apparatus 22, on the surface of the base material B having the cleaning layer and the functional layer formed thereon by the organic film forming apparatus 20.

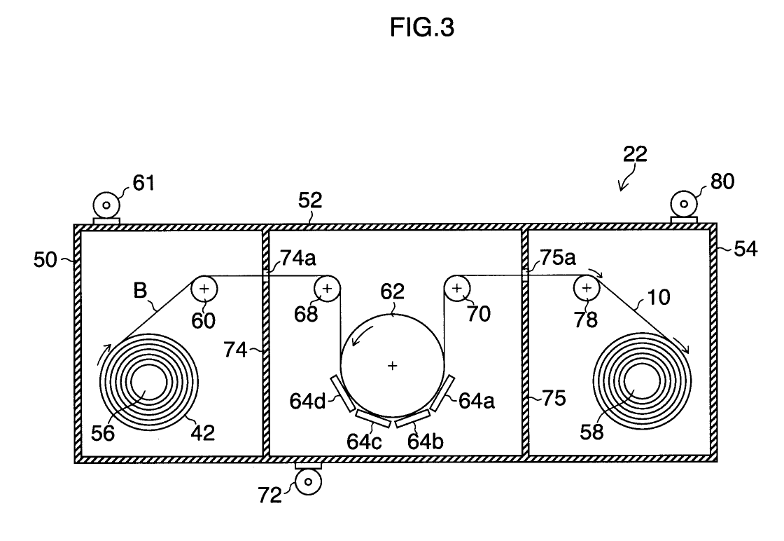

The base material roll 42, around which the base material B having the cleaning layer and the functional layer thereon is wound, is loaded in the vacuum film forming apparatus 22 as conceptually shown in FIG. 3. The vacuum film forming apparatus 22 forms a thin film by the vacuum film forming method on the surface of the base material B (i.e., on the surface of the functional layer) and is provided with a supply chamber 50, a film forming chamber 52 and a winding-up chamber 54.

Similar to the organic film forming apparatus 20, the vacuum film forming apparatus 22 is an apparatus to form a film by the roll-to-roll process, whereby the base material B is unrolled from the base material roll 42, delivered in the longitudinal direction while a thin film is formed thereon, and the film with the functional layer and the thin film formed thereon is wound up into a roll by a winding shaft 58.

The supply chamber 50 is equipped with a shaft 56, a transporting roller 60 and a vacuum exhaust device 61. In the vacuum film forming apparatus 22, the base material roll 42, around which the base material B comprising the formed films of the cleaning layer and functional layer is wound, is loaded on the shaft 56 in the supply chamber 50. When the base material roll 42 is loaded on the shaft 56, the base material B travels (is carried) through the predetermined delivery route from the supply chamber 50 through film forming chamber 52 to the winding shaft 58 in the winding-up chamber 54. In the vacuum film forming apparatus 22, the feeding of the base material B out of the base material roll 42 and the winding-up of the optical film 10 at the winding shaft 58 are carried out simultaneously in order to continuously form a thin film on the base material B while the long base material B is carried in the longitudinal direction along the predetermined delivery route.

In the supply chamber 50, the base material B is unrolled out of the base material roll 42 by rotating the shaft 56 clockwise in the drawing using a not shown driving source and guided along the predetermined route by the transporting roller 60 to the film forming chamber 52. Since the cleaning layer has been formed at the end of the running direction of the base material B, foreign matters on the transporting roller 60 are removed when the material passes therethrough.

The supply chamber 50 is further equipped with the vacuum exhaust device 61 which decompresses a pressure of the supply chamber 50 to a predetermined degree of vacuum (pressure) according to the film forming pressure of the film forming chamber 52. Thus, the pressure of the supply chamber 50 is prevented from adversely affecting the (film forming) pressure of the film forming chamber 52. The vacuum exhaust device 61 may be a known product as in the vacuum exhaust device 72 of the film forming chamber 52 to be described later.

The transporting roller 60 which comes in contact with the functional layer in vacuum is preferably a stepped roller which contacts only the edges of the base material B (the edges in the perpendicular direction (widthwise) to the running direction).

In addition to the members shown in FIG. 3, the supply chamber 50 may further be equipped with various members (delivery device) such as a pair of transporting rollers, guide members regulating the position of the base material B widthwise, etc., in order to carry the base material B along the predetermined route. However, since the supply chamber 50 has a degree of vacuum in accordance with the pressure of the film forming chamber during the formation of a thin film, members contacting the functional layer should be structured in such a manner as to contact only the edges of the base material B, as in the transporting roller 60 which is provided with steps.

The base material B is guided by the transporting roller 60 and delivered to the film forming chamber 52. The film forming chamber 52 is to form a thin film by the vacuum film forming method on the surface of the base material B (i.e., on the surface of the functional layer). In the illustrated embodiment, the film forming chamber 52 is provided with film a drum 62, forming devices 64 a, 64 b, 64 c and 64 d; transporting rollers 68 and 70; and a vacuum exhaust device 72. When the film forming chamber 52 is to form a film by sputtering, plasma CVD, or the like, the chamber is further provided with a high frequency power source, etc.

The base material B is delivered to the film forming chamber 52 through the slit 74a made in the partition wall 74 which separates the supply chamber 50 from the film forming chamber 52.

The vacuum film forming apparatus 22 shown in the illustrated embodiment is provided with, as a preferable embodiment, a vacuum exhaust device in both the supply chamber 50 and the winding-up chamber 54 to evacuate the supply chamber 50 and the winding-up chamber 54 in accordance with the pressure of the film forming chamber 52, but an apparatus for carrying out the present invention is not limited thereto. For example, instead of providing the vacuum exhaust devices in the supply chamber 50 and winding-up chamber 54, the film forming chamber 52 may be structured to be near airtight by minimizing the size of the slit through which the base material B passes without contacting the slit. Alternatively, sub-chambers may be provided through which the base material B passes between the supply chamber 50 and the film forming chamber 52 and between winding-up chamber 54 and the film forming chamber 52, wherein a vacuum may be created using a vacuum pump.

When a sub-chamber is provided upstream (upstream in the running direction of the base material B) of the film forming chamber 52, a device carrying the material inside the sub-chamber also must be structured so that the device contacts with only the edges of the base material B in the case the device contacts the functional layer. The drum 62 in the film forming chamber 52 is a cylindrical member which rotates counter clockwise in the drawing around the center line.

The base material B supplied from the supply chamber 50 and guided by the transporting roller 68 along the predetermined route is wound around the given area of the drum 62 circumference. The base material further travels along the predetermined delivery route while supported/guided by the drum 62, and a thin film is formed on the surface thereof (on the organic film 12 ) by the film forming devices 64 a to 64 d, and the like. When the film forming chamber 52 is used to form a film by sputtering, plasma CVD, or the like, the drum 62 may be grounded (earth) so as to serve as a counter electrode or connected to a high frequency power source.

The film forming devices 64a to 64d are to form a thin film on the surface of the base material B by the vacuum film forming method.

In the production method of the present invention, the method for forming a thin film is not limited, and any known vacuum film forming methods (vapor depositing method) such as CVD, plasma CVD, sputtering, vacuum vapor deposition, ion plating, etc., can be employed.

Accordingly, the film forming devices 64a to 64d include various members according to a vacuum film forming method to be performed.

For example, when the film forming chamber 52 is to form a thin film by ICP-CVD method (Inductively Coupled Plasma CVD), the film forming devices 64a to 64d include an induction coil to generate a magnetic field, a gas supply device to supply a reactive gas to a film forming area, etc.

When the film forming chamber 52 is to form a thin film by the CCP-CVD method (Capacitive-Coupled Plasma CVD), the film forming devices 64a to 64d include a hollow high frequency electrode with a plurality of pores on the face opposed to the drum 46 connected to a reactive gas supply source and a shower electrode serving as a reactive gas supply device, etc.

When the film forming chamber 52 is to form a thin film by the CVD method, the film forming devices 64a to 64d include a reactive-gas inlet device, etc.

Further, when the film forming chamber 52 is to form a thin film by sputtering, the film forming devices 64a to 64d include a target holding device, a supply device for high frequency electrodes, sputter gas, etc.

The vacuum exhaust device 72 evacuates the film forming chamber 52 and provides a degree of vacuum according to the formation of a thin film by a vacuum film forming method.

The vacuum exhaust device 72 is not limited, and various usable devices include vacuum pumps such as turbine pump, mechanical booster pump, rotary pump, etc.; and any known (vacuum) exhaust devices used for vacuum film forming apparatuses that employ supporting devices such as cryocoil, etc., adjustment devices for ultimate vacuum or displacement.

The base material B, i.e., the functional film 10, on which a thin film has been formed by the film forming devices 64 a to 64 d while being supported/carried by the drum 62 is guided along the predetermined route by the transporting roller 70, delivered to the winding-up chamber 54, and wound up into a roll around the winding shaft 58.

Since the cleaning layers have been formed on the base material B, foreign matters on the transporting rollers and like members contacting the base material B can be prevented from adhering to the functional layers.

Typically, the vacuum film forming apparatus 22 is open under atmospheric pressure for cleaning. After cleaning, the inside of the vacuum film forming apparatus must be evacuated again, thereby demanding much labor and time. On the other hand, using the base material B with the cleaning layers formed thereon enables easy cleaning of the inside of the vacuum film forming apparatus 22. Thus, the interruption frequency for cleaning the vacuum film forming apparatus 22 is significantly reduced.

Further, the laminated film (optical film) roll wound up into a roll is delivered to the organic film forming apparatus 20. Cleaning layers and a functional layer are newly formed on the base material B on which the thin film has been formed.

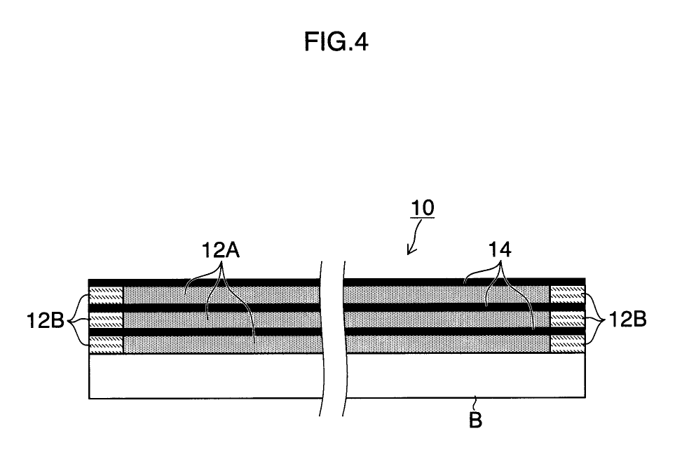

FIG. 4 shows the film 10 on which the film forming steps of the functional layer 12A and cleaning layer 12B as well as the thin film 14 have been repeatedly performed three times.

In FIG. 4, a thin film 14 is formed on each of the functional layer 12A and cleaning layers 12B. The cleaning layers 12B are always formed whenever the functional layer 12A is formed. Thus, the removal of foreign matters is ensured in any organic film forming apparatuses and inorganic film forming apparatuses.

When producing protection films for various devices and apparatuses such as organic EL display and LCD, the film may be a silicon oxide film, etc., made into a thin film.

Further, when producing anti-light-reflective films, light-reflective films, optical films such as various filters, a film may be formed using a material which can impart or express the desired optical properties as a thin film.

Among them, the present invention is the best suited for the production of a gas barrier film because a thin film with good gas barrier properties can be formed due to the excellent surface smoothness of the functional layer.

The method for producing an optical film according to the present invention has been described hereinabove, but the invention is not limited to the aforementioned embodiments and various modifications and changes can be made without departing from the scope of the invention.

### Examples

Hereinafter, the present invention will be described in more detail by way of specific Examples of the present invention.

98 g of a mixture of dipentaerythritol pentaacrylate and dipentaerythritol hexaacrylate (DPHA, made by Nippon Kayaku Co., Ltd.) was dissolved in 900 g of a methyl ethyl ketone solvent. 2 g of a photopolymerization initiator (Irgacure 907, made by Ciba Fine Chemicals, Inc.) was added to the obtained solution, and stirred and dissolved to make a coating fluid.

As a base material, TAC (triacetyl cellulose film), made by FUJIFILM Corp., 80 μm in thickness and 200 mm in width was used. The film travelling speed was set at 10 m/min.

### Comparative Example

The film was passed through rollers heated at 90° C., and then, the coating fluid containing the polymerizable compound of the above-mentioned composition was continuously applied on 90 m of the film using a #6-wire bar in a coating process. The applied film had a 90 m functional layer. After the coating fluid was applied, the film was dried at 100° C. in a heating process. Then, using an ultraviolet irradiation device (Light Hammer 10, 240 W/cm, made by Fusion UV Systems, Inc.) of a microwave light emission type mounting a D-Bulb having a strong light emission spectrum at 350 to 400 nm as a UV light source, the polymerizable compound was polymerized by UV irradiation for 1 sec at a position 5 mm from the focal point in the UV irradiation device 30. The irradiation was carried out with an irradiation energy of 1.0 J/cm². Thereafter, the irradiated film was allowed to cool to room temperature to obtain a long film, which was then wound up. In the UV irradiation, a nitrogen gas of 99.9999% in purity as an inert gas was used. The temperature of the nitrogen gas was 22° C.

### Example

The film was passed through rollers heated at 90° C., and then, the coating fluid containing the polymerizable compound of the above-mentioned composition was continuously applied on 90 m of the film using a #6-wire bar in a coating process. The applied film had a 30 m cleaning layer, a 30 m functional layer, and a 30 m cleaning layer. After the coating fluid was applied, the film was dried at 100° C. in a heating process. Then, using an ultraviolet irradiation device (Light Hammer 10, 240 W/cm, made by Fusion UV Systems, Inc.) of a microwave light emission type mounting a D-Bulb having a strong light emission spectrum at 350 to 400 nm as a UV light source, the polymerizable compound was polymerized by UV irradiation for 1 sec at a position 5 mm from the focal point in the UV irradiation device 30. The irradiation was carried out with an irradiation energy of 0.1 J/cm² for the cleaning layers and that of 1.0 J/cm² for the functional layer. Thereafter, the irradiated film was allowed to cool to room temperature to obtain a long film, which was then wound up. In the UV irradiation, a nitrogen gas of 99.9999% in purity as an inert gas was used. The temperature of the nitrogen gas was 22° C.

Then, an aluminum oxide film 40 nm in film thickness as an inorganic film was formed on the organic film 12 using a sputtering apparatus. For forming the aluminum oxide film, aluminum as a target, argon as a discharge gas, and oxygen as a reaction gas were used.

### (Evaluations)

The surface of the laminated films produced under the above-mentioned conditions was observed by SEM. A case where foreign matters on the functional layer 12A had a size equal to or less than 1,000 nm and the number thereof per 1 m² was equal to or less than 500,000 was defined as “GOOD” and a case other than the case was defined as “BAD”. The observation results are shown in Table 1.

TABLE 1

| | Foreign matter observation result |
|---|---|
| Comparative Example | BAD |
| Example | GOOD |

As is clear from the above results, the cleaning effect of the present invention could be obtained by the above-explained Example.

What is claimed is:

1. A film comprising:
a long base material;
a cleaning layer formed at an end of the long base material surface in a running direction; and
a functional layer formed on an area of the long base material surface where the cleaning layer is not formed.

2. The film according to claim 1, wherein the cleaning layer and the functional layer have the same composition and are formed under different film forming conditions.

3. The film according to claim 1, wherein the cleaning layer and the functional layer contain a radiation curable monomer or oligomer.

4. The film according to claim 2, wherein the cleaning layer and the functional layer contain a radiation curable monomer or oligomer.

5. A method for producing a film, comprising the steps of:
feeding a long base material;
applying a coating liquid to the long base material;
forming a cleaning layer by treating the applied coating liquid under first film forming conditions;
forming a functional layer by treating the applied coating liquid under second film forming conditions which are different from the first film forming conditions; and
winding up the long base material.

6. The method for producing a film according to claim 5, further comprising a step of forming a cleaning layer by treating the coating liquid under first film forming conditions after the step of forming the functional layer.

7. The method for producing a film according to claim 5, wherein the coating liquid contains a radiation curable monomer or oligomer.

8. The method for producing a film according to claim 6, wherein the coating liquid contains a radiation curable monomer or oligomer.

9. The method for producing a film according to claim 7, wherein the second film forming conditions are different in a radiation intensity from the first film forming conditions, and the radiation intensity in the first film forming conditions is lower than the radiation intensity in the second film forming conditions.

10. The method for producing a film according to claim 8, wherein the second film forming conditions are different in a radiation intensity from the first film forming conditions, and the radiation intensity in the first film forming conditions is lower than the radiation intensity in the second film forming conditions.
